(19) United States
(12) Patent Application Publication
(10) Pub. No.: US 2015/0331589 A1
(43) Pub. Date: Nov. 19, 2015

(54) CIRCULAR INTERFACE FOR NAVIGATING APPLICATIONS AND AN AUTHENTICATION MECHANISM ON A WEARABLE DEVICE

(71) Applicant: Todd KAWAKITA, Fullerton, CA (US)

(72) Inventor: Todd KAWAKITA, Fullerton, CA (US)

(21) Appl. No.: 14/713,421

(22) Filed: May 15, 2015

Related U.S. Application Data
(60) Provisional application No. 61/993,380, filed on May 15, 2014.

(51) Int. Cl. G06F 3/0484; G06F 3/0488; G06F 3/0481

(52) U.S. Cl. CPC G06F 3/04842; G06F 3/0481; G06F 3/0488

(57) ABSTRACT

In one aspect, the present disclosure relates to a touch- and/or physical control-enabled wearable computer includes a circular user interface with interface regions set along the outer edge of the display and a concentric content display area. The interface regions allow the user to switch between applications and scroll/select actions within applications. The content display area shows information for the current foreground application and can include additional interface regions specific to an application.

### CROSS REFERENCE TO RELATED APPLICATIONS

This application claims the benefit of U.S. Provisional Pat. App. Ser. No. 61/993,380, filed on May 15, 2014, which is hereby incorporated by reference in its entirety.

### BACKGROUND

Current portable electronic data and communication devices are primarily touchscreen-based user interfaces. Many of these user interfaces are stored in a pocket, purse, or bag when not being used and have screens typically greater than 3-4″ diagonally, such as with smart phones or tablets. Using these devices often requires the user to retrieve them from a storage position, turn on and unlock the display, and then find and launch an application.

Wearable computers such as smart-watches do not need to be retrieved from storage and are generally on a person for the entire day. This form factor provides the user with an opportunity to quickly access and act on information, provided that the user interface facilitates this task. It also provides the opportunity for the wearable to serve as an authentication device that only has to be authenticated when first worn, provided that the device can check that it remains securely attached to a person.

### SUMMARY

In one aspect, the present disclosure relates to a touch- and/or physical control-enabled wearable computer includes a circular user interface with interface regions set along the outer ring of the display and a content display area within that ring. The interface regions allow the user to switch between applications and scroll/select actions within applications. The content display area shows information for the current foreground application and can include additional interface regions specific to an application.

Within an application-switching context, the interface regions can correspond to applications that can be switched between by the user.

Within the current foreground application, the interface regions can correspond to actions that can be selected by the user to update the current foreground application. A clockwise or counterclockwise gesture enables scrolling within certain applications.

To control the circular interface, for both application switching and selecting actions or scrolling within an application, three specific hardware manifestations are described in detail: one involving a full touchscreen, one involving capacitive touch sensors, and one involving only physical controls.

The wearable computer also includes an authentication mechanism that checks that the wearable device is securely attached to a user. This way the device only has to be authenticated when first worn and can then be used to communicate to other devices without additional authentication.

In one aspect, the present disclosure relates to a circular user interface for a wearable computer. In some embodiments, the user interface can include: interface regions placed along the outer rim of the circular interface; a central view for the currently active application in a concentric circle to the outer rim; software for switching between applications using these interface regions; software for selecting actions within an application using these interface regions; software for scrolling through views or updating some progress bar within an application using a clockwise or counterclockwise gesture; and software for enabling and disabling an application switching mode.

In one aspect, the present disclosure relates to a wearable computer including a display, a processor, a wireless transceiver, and a battery. In some embodiments, the wearable computer can also include internal storage, wrist strap, vibrating motor, speaker, camera, accelerometer, magnetometer, ambient light sensor, IR blaster, or heart rate sensor.

In some embodiments, the wearable computer registers selections of the interface regions a scrolling motion in the interface and the enabling or disabling of application switching mode.

In some embodiments, the touchscreen can enable or disable application switching mode such as with a peripheral application switching button or a gesture such as pinch in/out; and registers the actions in addition to any touch input in the central view specific to an application.

In some embodiments, capacitive sensors can enable or disable an application switching mode such as with a peripheral application switching button; and a series of capacitive sensors in the bezel for each interface region that registers the actions.

In some embodiments, physical controls can enable or disable an application switching mode such as with a peripheral application switching button; a series of physical buttons in the bezel for each interface region that registers; and a rotating wheel on the wearable device that registers actions.

In some embodiments, the wearable computer can include an authentication system such that the system can detect that a wearable computer such as a watch is securely tied to a person and that person can enter in a passcode. The wearable computer remains authenticated until the device detects that it is no longer securely tied to the person or if otherwise directed by the user.

### BRIEF DESCRIPTION OF THE FIGURES

FIG. 1 illustrates the circular user interface with interface regions set along the outer ring of the display and the content display area within that ring, according to embodiments of the present disclosure.

FIGS. 2a and 2b illustrate the Application Switching Mode of the user interface, according to embodiments of the present disclosure.

FIGS. 3a and 3b illustrates the Within Application Mode of the user interface via an example music application, highlighting how the application is updated by selecting actions and scrolling, according to embodiments of the present disclosure.

FIG. 3c demonstrates how Application Switching Mode can be engaged from Within Application Mode at any time without leaving the current application view, according to some embodiments of the present disclosure.

FIGS. 4a, 4b, and 4c provide another illustration of the Within Application Mode of the user interface via an example weather application, highlighting the placement of ordinal information along the concentric circle in the content display area, according to some embodiments of the present disclosure.

FIGS. 5a, 5c, and 5d provide another illustration of the Within Application Mode of the user interface via an example mail application, highlighting how overflow content can be displayed, according to some embodiments of the present disclosure.

FIG. 5b illustrates a modification of FIG. 5a for hardware manifestations without touchscreens, according to some embodiments of the present disclosure.

FIG. 5e provides an illustration of how Within Application Mode can launch another application by selecting an action on the outer ring, according to some embodiments of the present disclosure.

FIGS. 6a and 6c provide another illustration of the Within Application Mode of the user interface via an example contacts application, highlighting how there may be many interface regions set along the outer ring of the display and actions can be assigned to the outline of the concentric circle that is in the content display area, according to some embodiments of the present disclosure.

FIG. 6b illustrates a modification of FIG. 6a for hardware manifestations without touchscreens, according to some embodiments of the present disclosure.

FIGS. 7a-7e illustrate how notifications might work on the wearable device, according to some embodiments of the present disclosure.

FIG. 7f shows the Within Application Mode for an embodiment of a messaging application or conversation thread relating to a given notification, according to some embodiments of the present disclosure.

FIGS. 8a and 8b summarize generalized interface elements of regions that extend FIG. 1 for example applications, according to some embodiments of the present disclosure.

FIGS. 9a, 9b, and 9c illustrate the touchscreen hardware manifestation of the wearable device, according to some embodiments of the present disclosure.

FIGS. 10a and 10b illustrate the capacitive touch hardware manifestation of the wearable device, according to some embodiments of the present disclosure.

FIGS. 11a and 11b illustrate the physical control hardware manifestation of the wearable device, according to some embodiments of the present disclosure.

FIG. 12 provides a non-exhaustive list of possible interactions on the wearable device, according to some embodiments of the present disclosure.

FIG. 13 illustrates an authentication mechanism for the wearable device, according to some embodiments of the present disclosure.

### DESCRIPTION

The proposed circular interface for a wearable device places user interface regions along the outer ring of the interface while the circular area within the ring displays the view relating to the current foreground application. Having these regions placed around the outer rim, in a fashion similar but not limited to the eight directions of a compass (N, S, E, W, NE, NW, SE, SW), and mapped to specific functions allows for rapid selection without leaving the current application view. If the user has these mappings memorized, he/she can switch applications without looking at the wearable's display.

As an example, consider a situation with eight interface regions, each representing an application that can be switched to. One region is currently selected as the foreground application but by activating Application Switching Mode one can switch to the other seven applications via selection of a different interface region. This is done without leaving the current application view. In some existing systems, switching applications takes the user out of the current application view and can take multiple gestures, such as swipes or button presses (here up to seven), to launch the desired application. Once an application has been selected to switch to, that application is brought to the foreground and the device is now in Within Application Mode.

In the foreground application's Within Application Mode, the outer ring interface regions are replaced with actions specific to the application, rather than showing potential applications to switch to. These actions provide specific user input functionality for the foreground application and can impact the view within the content display region: e.g., pressing send for an email an email application or accessing a secondary view in an application. As part of this mode, certain applications allow scrolling using a clockwise or counterclockwise gesture such as a circular swiping touch gesture or by rotating a physical wheel, based on the hardware manifestations of present disclosure. Scrolling allows for content such as a progress bar placed around a circle to be updated; ordinal content, such as time, days of the week, etc., to be arranged around a circle and then “wound” or “unwound” to view additional content that is not yet exposed; or selection of a particular option or value from a set placed around a circle using this scrolling gesture.

The circular interface has three different hardware manifestations. One uses a touch-screen with additional peripheral buttons, a second uses capacitive-touch with additional peripheral buttons, and a third uses solely physical controls and buttons.

The touchscreen version uses touch input gestures, typically swipe or tap gestures, on the outside interface regions to register a selection. Scrolling involves a clockwise or counterclockwise swiping motion over a scrolling region within the content display area for applications with this functionality. Either pressing a peripheral button or using a gesture such as “pinch in”/“pinch out” engages or disengages Application Switching Mode; other peripheral buttons might exist for additional functions such as a back button functionality or a home button. Alternatively, a clockwise or counterclockwise swipe on the top half of outer interface ring can provide forward and backward button functionality.

The capacitive touch hardware manifestation has touch sensor regions on the bezel assigned to each interface region on the display that registers selections of a given interface region. A clockwise or counterclockwise scrolling gesture over these capacitive touch sensor regions allows scrolling within an application where this functionality is enabled. The hardware also includes a peripheral button(s) for engaging/disengaging Application Switching Mode or for back button or home button functionality.

The physical control hardware manifestation has a physical button on the bezel assigned to each interface region on the display that registers selections of a given interface region, and a rotating wheel for scrolling along one side of the wearable computer. This rotating wheel is preferably placed on the bottom side of the wearable, rather than the left or right side, to allow for symmetrical use by either the right or left hand by thumbing along the rotating wheel. The hardware also includes a peripheral button(s) for engaging/disengaging Application Switching Mode or for back button or home button functionality. The physical control version can also be used while wearing gloves or while under water, functions touch-enabled devices have difficulty supporting.

A wearable device such as a watch also allows for applications in authentication. By having an electrical line in the wristband combined with a heart rate, skin conductance, and/or another appropriate sensor on the back of the watch to ensure that the watch is not loose and detect with a high probability the quality of a human being alive, one could make sure that the wearable is securely attached to the user. Then by putting in a passcode, the wearable device can remain authenticated until it is taken off and during that time securely communicate with other devices.

The device includes multiple hardware components, including but not limited to a circular face and display, a processor, wireless transceiver, battery, internal storage, wrist strap, vibrating motor, speaker, camera, accelerometer, magnetometer, ambient light sensor, IR blaster, heart rate sensor, or skin conductance sensor.

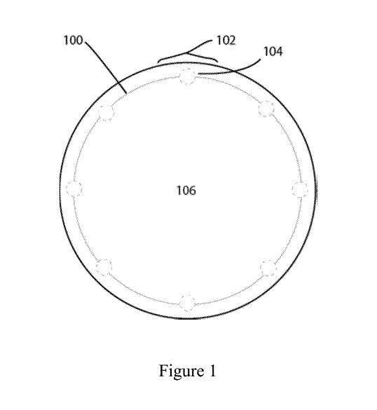

FIG. 1 illustrates the circular user interface where the outer ring of the display 100 has contiguous interface regions such as 102 evenly spaced around it. Each interface region is represented by an icon 104. In FIG. 1, there are eight such user interface regions icons but there may be fewer or more than this number in different application contexts. Within the outer ring is a content display area, 106, that can contain other interface elements and regions specific to the content being displayed.

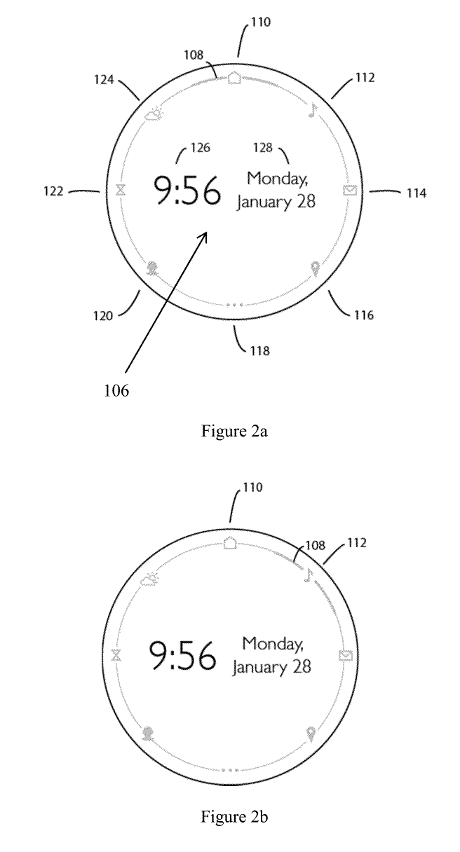

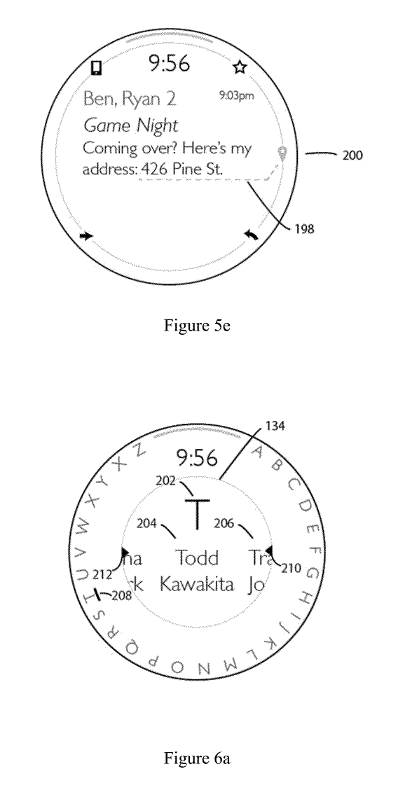

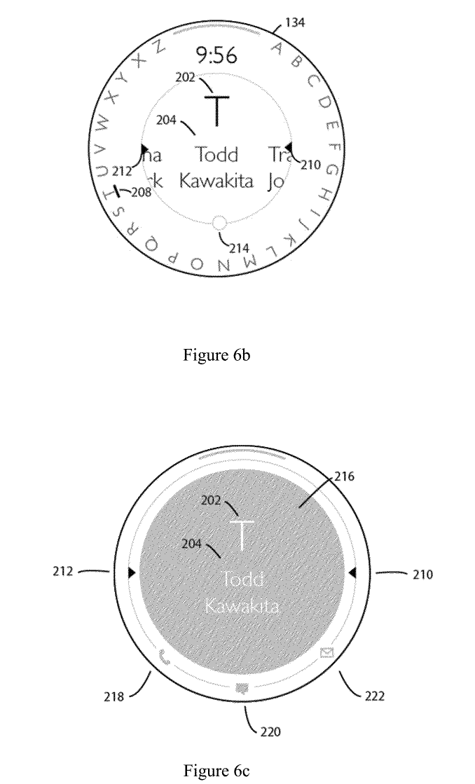

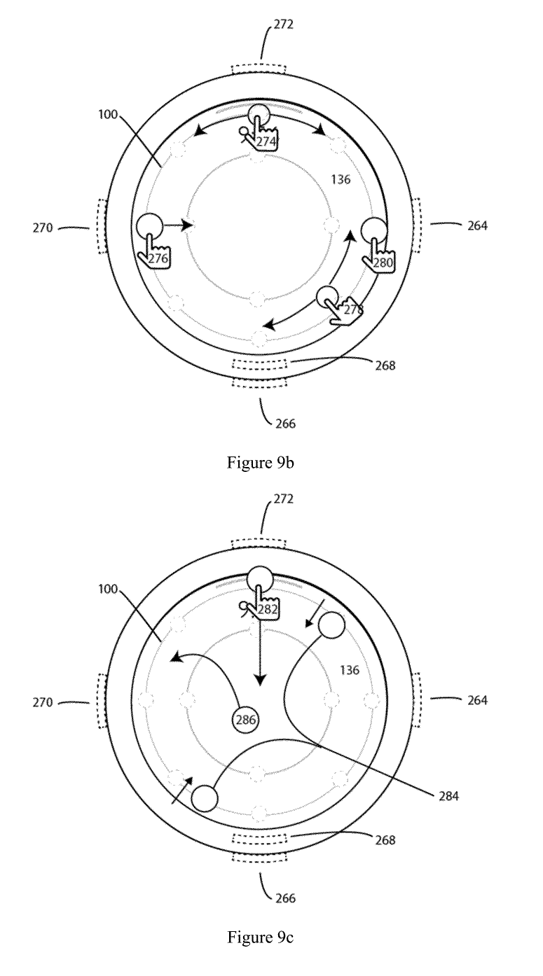

FIG. 2a illustrates one of the main modes of the user interface: Application Switching Mode. The ways in which Application Switching Mode can be engaged for different hardware manifestations are discussed in FIG. 9b-9c, 10b, and 11b. When Application Switching Mode is engaged, application icons for an interface region can include, for example, 110 (home), 112 (music), 114 (mail), 116 (maps), 118 (more applications), 120 (contacts), 122 (timer), and 124 (weather). In this mode, applications are pinned to the interface regions for quick selection. The current foreground application is highlighted by an indicator 108: in this figure, the home application, 110, is the currently active application that has its content shown in the content display area, 106. In content display area 106, the time 126 and date 128 are displayed as one embodiment for the home application. The home application may take on different embodiments that may include but are not limited to additional information such as weather, or showing alternative watch faces using analog-appearing hour and minute hands. The interface can accommodate additional applications by reserving one interface region to display additional applications 118. Selecting this interface region replaces the other interface regions—110, 112, 114, 116, 120, 122—with different application icons or alternatively allows one to scroll through all applications through a view similar to the contacts application in FIG. 6a such that applications are categorized, e.g., alphabetically by name, and the application's icon and name are shown in the concentric circle 134, instead of 202 and 204, respectively.

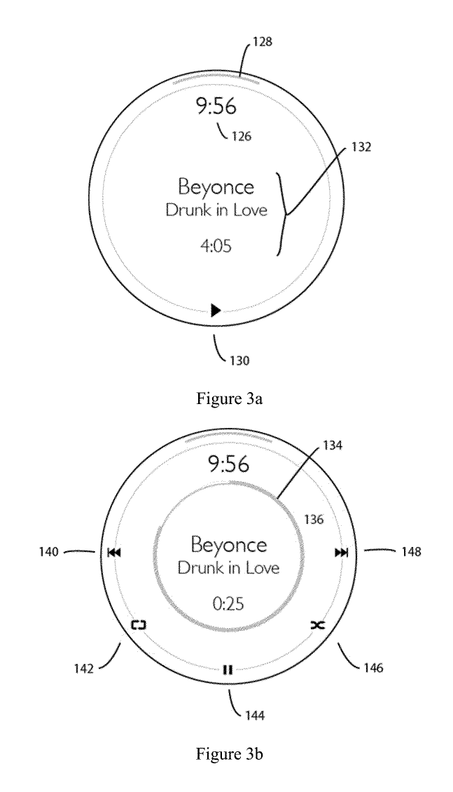

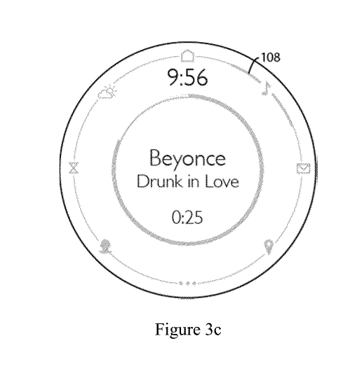

FIG. 2b illustrates how the application the user has decided to switch to is indicated in Application Switching Mode. By selecting the interface region 112 (music) after the user engages Application Switching Mode, the foreground application is switched from the home application 110 to the music application 112 and the music application is momentarily highlighted with the indicator for the foreground application 108. This then launches a view of the music application and makes it the foreground application, which is shown in FIG. 3a, and puts the device in Within Application Mode.

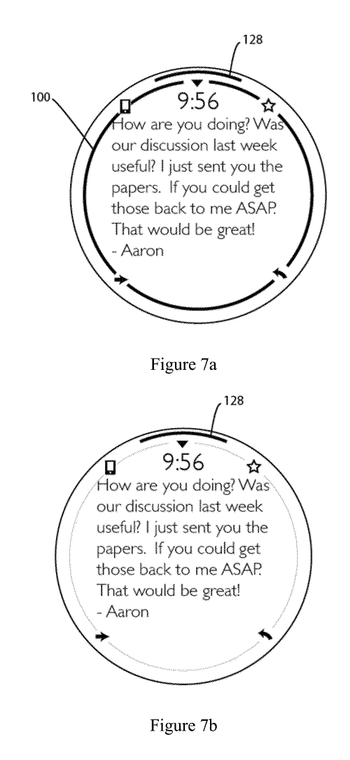

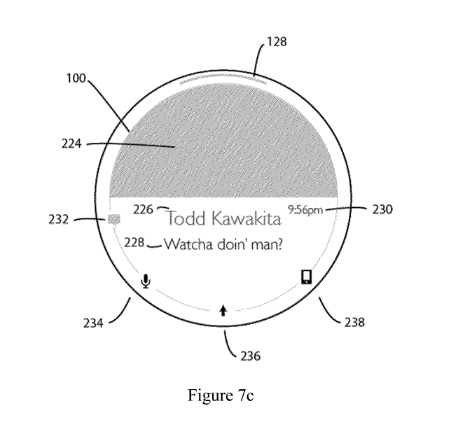

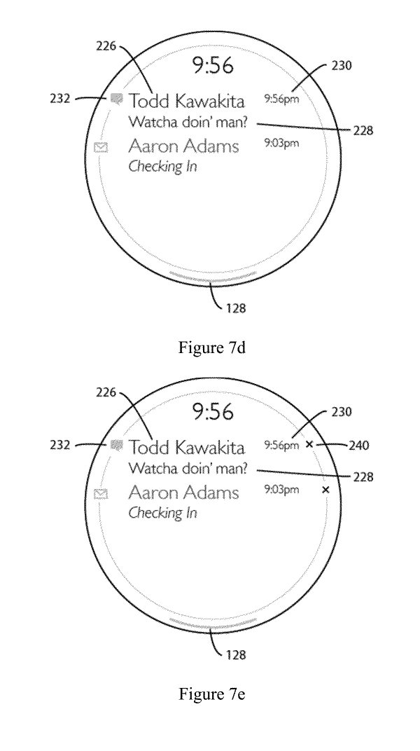

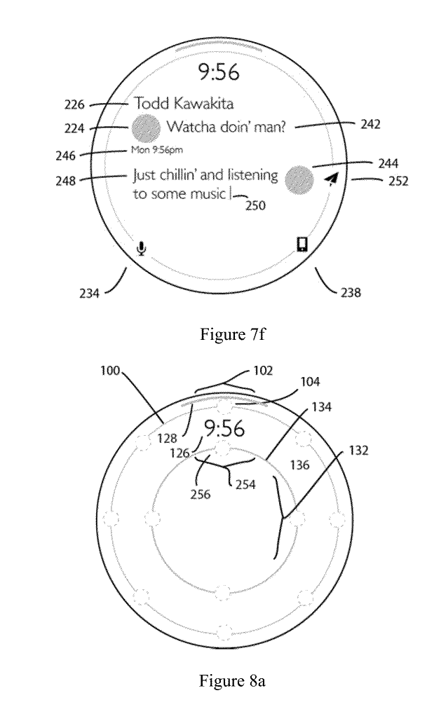

FIG. 3a illustrates Within Application Mode through the example of a music application. The interface regions previously representing applications are replaced with actions specific to the foreground music application such as a play button 130. The content display area, 106 from FIG. 1, now shows content relevant to the foreground music application, 132. In Within Application Mode, the time, 126, is viewable at almost all times and a notification bar 128 that can be brought up is also visible. FIG. 7a-7e describe notifications in greater detail.

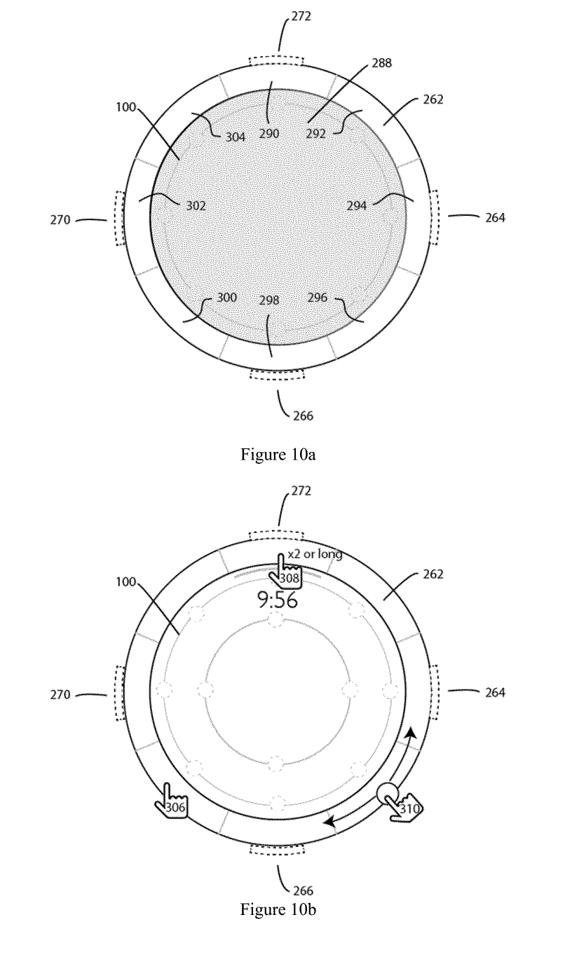

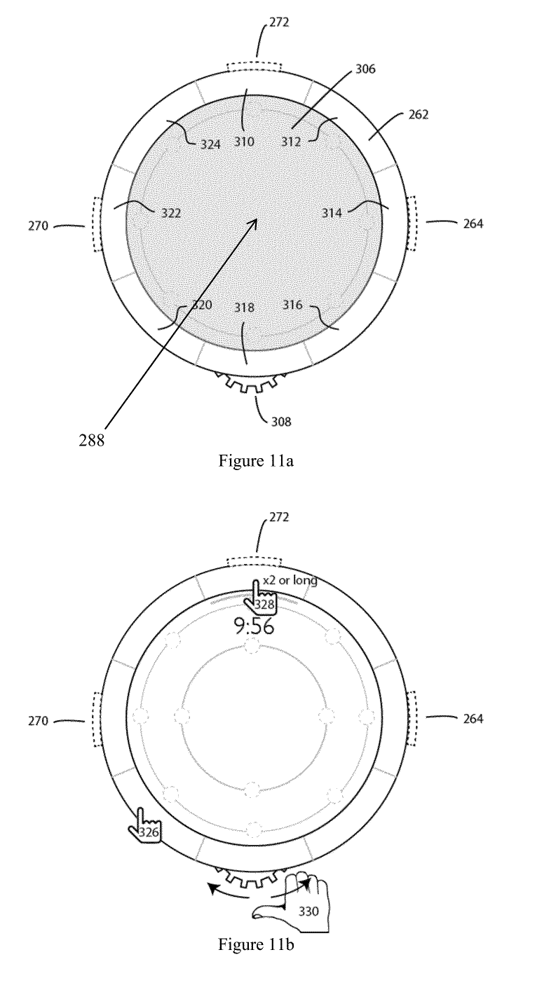

FIG. 3b continues to illustrate Within Application Mode, specifically showing how selecting an action can update the view and/or provide user input. For instance, selecting the play music action, 130, in FIG. 3a updates the content display area to show a concentric circle, 134, that functions as a progress bar and also changes the actions available along the outer ring from a single play button, 130, to five different buttons—140 (previous track), 142 (repeat), 144 (pause), 146 (shuffle), and 148 (next track). The donut-shaped area between the concentric circle, 134, and the outer ring indicated by 136 is a region that indicates that this application allows for scrolling, in this case scrubbing forward and backward on the track being played, which updates the progress bar on the concentric circle 134. The circular indicator along the concentric circle, 134, and the scrollable region, 136, constitute part of a circular design paradigm taking advantage of the circular interface. In the touchscreen manifestation of the wearable computer described further in FIGS. 9a-9c, a clockwise or counterclockwise touch motion along 136 scrubs the track. Scrolling using other manifestations is described further in FIGS. 10b and 11b.

FIG. 3c shows how Application Switching Mode can be engaged at any time from Within Application Mode without leaving the current application view. Unlike some existing interfaces, there is no need to back track through a menu hierarchy to reach a home or parent menu for application switching. The foreground application's content display area from FIG. 3b remains visible until a different application is selected to switch to, and foreground application indicator 108 indicates the current application's music.

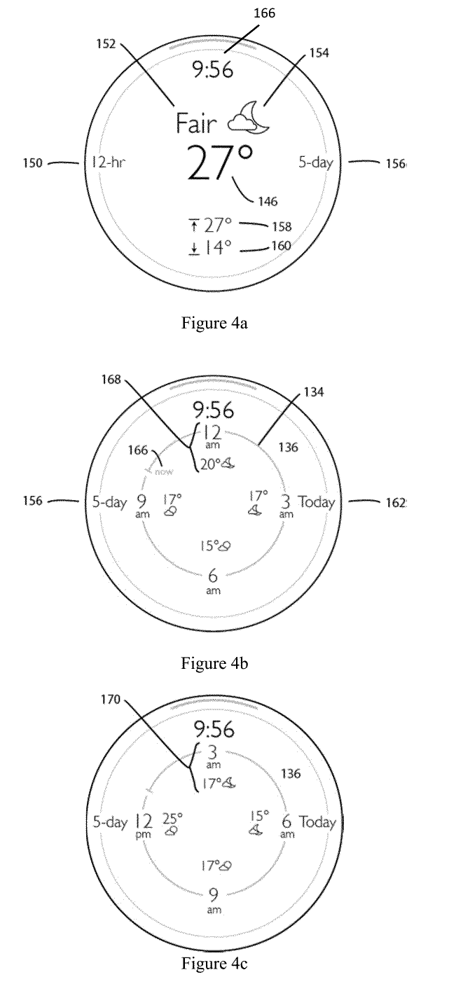

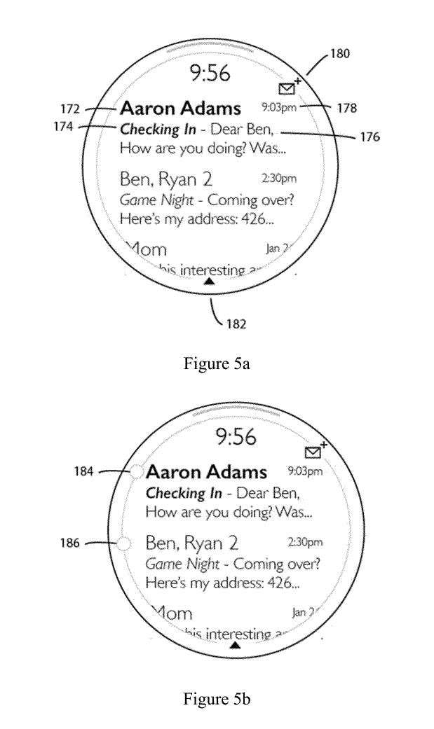

FIG. 4a shows an additional example of an application in Within Application Mode through a weather application. As part of its content display area, the application includes a textual description of the current weather 152, weather icon 154, temperature 146, high 158, low 160, and actions 150 and 156 to access views corresponding to 12-hour and 5-day forecasts, respectively.

FIG. 4b shows the 12-hour forecast view to illustrate a variation on the circular design paradigm, presented in FIG. 3b. Here, ordinal information, such as time or days of the week, is placed along the concentric circle, 134. Rather than having a progress bar along 134 such as in FIGS. 3b-3c, ordered information can be placed along this circle. Specifically, a marker for the current time is indicated by 166 on this circle and markers every four hours thereafter for the next 12 hours are placed around a circle, starting with 168 for the temperature at 12 a.m. Similar to FIG. 3b, conducting a scrolling gesture in area 136, specifically in a counterclockwise motion, allows the user to see beyond the next 12 hours to provide the user with the view in FIG. 4c. Action 156 from FIG. 4a has been replaced Action 162 to return to the today forecast view from FIG. 4a.

FIG. 4c shows an altered view resulting from a counterclockwise scrolling gesture on area 136 from FIG. 4b. The first four-hour increment, originally 168 in FIG. 4b indicating temperature at 12 a.m., becomes hidden as each increment shifts back by a marker in the counterclockwise direction and 170 for the temperature at 3 a.m. has taken 168's place. This is part of a circular design paradigm in which information can be “unwound” from a circle.

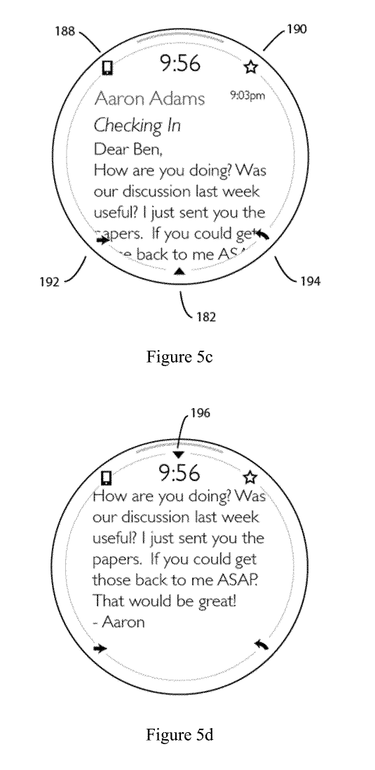

FIG. 5a shows an additional example of Within Application Mode through a mail application illustrating how overflow content such as but not limited to text or list views can be presented in the circular design paradigm. For instance, the mail application includes a list of emails in an inbox, for each email indicating the sender 172, subject 174, a preview of the first few lines of the email 176, and the timestamp 178. Region 180 provides an action to compose a new email. Doing so may open a view similar to FIG. 6a-6c's contacts application where the user could select recipients for the email from his/her contacts. 182 provides an action to view the overflow text in the content display area. In the touchscreen manifestation of the wearable computer described further in FIG. 9a-9c, swiping up on the content display area performs the same action as selecting 182 and tapping on an individual email in the list view opens that email up.

FIG. 5b is an alternative view to FIG. 5a for other manifestations of the wearable computer without a touchscreen. The only distinction from FIG. 5a is that each individual list item is opened by selecting an action on the outer ring linked to that item instead of tapping on the individual item itself.

FIG. 5c shows the view in the content display area for opening up an individual email. Actions include but are not limited to opening the email on a companion device with a larger screen for editing 188, favorite-ing an email 190, forwarding an email 192, and replying to an email 194. The action 182 lets you view the overflow text, in the same manner as FIG. 5a.

FIG. 5d shows the result of selecting the action 182 or in the touchscreen manifestation swiping up on the content display area. The previously hidden overflow text is now visible and 182 is no longer visible since there is no more overflow text to show. Now action 196 is available to view the previously visible text and scroll back up.

FIG. 5e shows how an action can launch another application from Within Application Mode using an action pinned to the outer ring. As a specific embodiment for the same mail application, the dotted underline of 198 indicates that part of the content of an email has been detected as an address and is linked to an action launching the maps application, 200, for the address.

FIG. 6a shows an example contacts application in which the circular interface can have 26 interface regions for each letter of the alphabet, more than the eight potential interface regions along the outer ring shown in FIG. 1. For the Within Application Mode of this contacts application, 208 is an indicator of the active letter along the outer ring and 202 is an indicator of that same active letter but shown in the concentric circle. The active contact name is indicated by 204. A clockwise scrolling gesture advances through the individual names, for instance, going from 204 to 206, within the concentric circle 134, while simultaneously advancing the active letter indicator 208 when the first letter of the contact's first name switches from one letter to another. Actions 210 or 212 allow the user to move through individual names left or right as an alternative, perhaps more fine-grained, alternative gesture to scrolling. In the touchscreen hardware manifestation, a scrolling gesture along the region 136 in a clockwise or counterclockwise motion would allow the user to cycle through contacts; swiping from right to left on the concentric circle 134 would have the effect of advancing one contact from 204 to 206 or in the reverse direction; touching and as one possible embodiment holding then lifting one of the 26 regions on the outer ring would jump to contacts starting with that letter; and tapping the concentric circle showing the active contact would open it. FIG. 6b shows a modified version of this interface for other hardware manifestations without a touchscreen.

FIG. 6b shows the same example contacts application as FIG. 6a but for other hardware manifestations without a touchscreen. In these hardware manifestations, there would be fewer than 26 sensors or buttons, likely only eight around the display. As a result, jumping to contacts by touching a sensor or button is not possible since there is not a one-to-one mapping between a sensor/button and an individual letter's interface region on the display. Instead, pressing a sensor/button around the display area would correspond to the available actions on the concentric circle 134, such as 210 to advance to the next contact or 214 to actually open the contact, rather than one of the interface regions for a particular letter of the alphabet on the outer ring. Details for hardware manifestations without a touchscreen are shown in FIG. 10a-10b and 11a-11b. 214 is the only addition in going from FIG. 6a to FIG. 6b, which is necessary since the user cannot tap the concentric circle as with a touchscreen. A scrolling gesture still scrolls through the contacts, details of which for non-touchscreen hardware manifestations are referenced in FIG. 10a-10b and 11a-11b. To achieve the effect of directly jumping to a letter on the outer ring, a different gesture such as a long press of one of the sensors or buttons can be used to move the indicator 208 to the first letter within the corresponding interface region. Combining this within a short time interval with a scrolling gesture, can allow the user to move the individual letter indicator 208 around the outer ring and jump to a specific letter. This can be faster than having to advance through all letters preceding the desired letter.

FIG. 6c shows the view resulting from opening up a contact. The first letter of the contact's first name 202 along with the contact's full name 204 remain in the same place but an image of the contact appears behind these as 216. The actions 210 and 212 allow the user to move between adjacent contacts as before in FIG. 6a and actions such as calling (218), messaging (220), and emailing (222) the contact are available, which launch the corresponding applications.

FIG. 7a shows one of two ways in which notifications could work on the circular interface. Assume the user has the mail application open as in FIG. 5d. as the foreground application, and then receives a notification. When receiving this notification, the outer ring, 100, flashes and/or highlights for a period of time, accompanied by an optional vibration, and the notification bar, 128, remains highlighted to indicate that there are unchecked notifications, as shown in FIG. 7b.

FIG. 7b continues to show from FIG. 7a one of two ways in which notifications can work. After the outer ring, 100, has flashed for a period of time, accompanied by a vibration, the notification bar, 128, remains highlighted to indicate that there are unchecked notifications. The user can then open the notifications panel shown in FIG. 7d using the notifications bar, 128.

FIG. 7c shows a second way in which notifications can work on the circular interface. As in FIG. 7a the user has the mail application open as in FIG. 5d, but in this situation the notification takes over most of the screen rather than flashing the concentric circle, 100, and having the user elect to later check his/her notifications through the notifications panel. This full-screen notification may include a picture of the sender, 224, the name of the sender, 226, and a one-line preview, 228, along with the timestamp, 230. It also may include actions to: immediately respond by voice on the wearable, 234, or on a companion device with a larger screen, 238; open the notification in its corresponding application on the wearable, 232, without responding immediately; or dismiss the notification, 236, to return to the initial view of FIG. 5d. The notification may also be dismissed by using the peripheral back button or gesture, explained later in the discussion of hardware embodiments in FIG. 9b-9c, 10b, and 11b, which would also take the user back to the view in FIG. 5d. Dismissed notifications may still appear in the notifications panel shown in FIGS. 7d and 7e. In the event that multiple notifications appear at the same time and are layered on top of each other, the user may hold the dismiss action 236 for a longer period of time to dismiss all underlying notifications so he/she does not have to dismiss each one individually. Additionally, since the user has seen the notification and dismissed it, the notification bar, 128, is no longer highlighted as it would be in FIG. 7b but it is still accessible for viewing.

FIG. 7d shows what happens when the notification bar, 128, from Within Application Mode is opened to show the notifications panel: this panel is always accessible in Within Application Mode, as discussed in FIG. 3a. Notifications may be stacked from top down in order of most recent to least recent. Each notification provides an action to open it in the application it corresponds to in this case the messaging application, 232, the name of the sender, 226, a one-line preview, 228, and the timestamp, 230. The notification bar, 128, now appears at the bottom and is no longer highlighted since notifications have now been checked. On the touchscreen hardware manifestation, a long swipe down or up can open and close this panel, respectively; additionally, selecting the action to open the notification in the application, or swiping left or right on the notification content, consisting of 226, 228, and 230, may remove the notification from the panel. On other hardware manifestations, a double tap or press on the top or bottom sensor or button may open and close the notifications panel, respectively. FIGS. 9b-9c, 10b, and 11b further explain some of these interactions for different hardware embodiments. FIG. 7e shows a modified version of the notifications panel for hardware manifestations without a touchscreen, which still allows for notifications to be removed from the panel without having to open the notification in its corresponding application.

FIG. 7e shows the same notifications panel as FIG. 7d but for other hardware manifestations without a touchscreen. Here the only addition from FIG. 7d is an action to remove each notification from the panel, 240.

FIG. 7f shows the result of launching the messaging application from the notifications panel in FIGS. 7c, 7d, and 7e using action 232 and then triggering action 234 for voice input. Alternatively the user could directly trigger action 234 for voice input in FIG. 7c. The content of the user's reply message is shown in 248 and the cursor 250 indicates that the message has not yet been sent and more voice input can be added. The send action is specified by region 252. 226 can indicate the name of the person the user is messaging with, 224 is an image for that person, 242 is the content a message from that person, and 246 is the timestamp for that message.

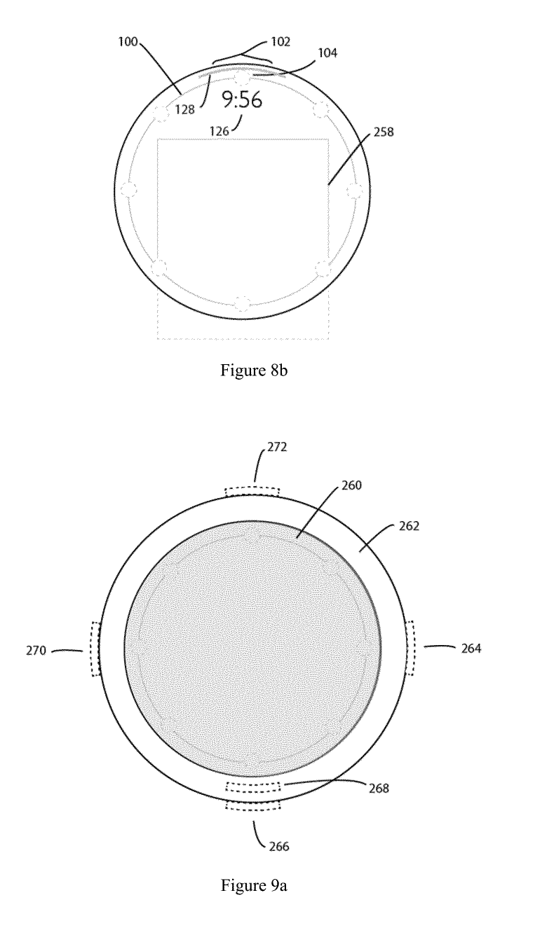

FIG. 8a extends FIG. 1 by showing an embodiment of a set of possible generalized interface elements and regions that might appear in the content display area, 106, when in Within Application Mode for applications with scrolling functionality, such as the music, weather, and contacts applications embodiments presented in FIGS. 2a-2c, 3a-3c, 6a-6c. To summarize the functionality in FIGS. 2a-2c, 3a-3c, and 6a-c's embodiments, the interface regions such as 102 and 104 along the outer ring, 100, correspond to actions within the context of an application. In Within Application Mode, the content display area defined as 106 in FIG. 1 contains the time 126 and an additional concentric circle, 134, that can contain its own content, 132, in addition to having information or action in along its outline. Examples of information along 134 included a progress indicator in the music application embodiment, or hours of the day or other ordinal information in the weather application embodiment. Examples of actions along the concentric circle 134 included the next and previous individual contact actions in the contacts application embodiment. The donut-shaped region, 136, between the concentric circle, 134, and the outer ring, 100, provided a region to scroll on the touchscreen hardware manifestation. The other hardware manifestations without a touchscreen can also scroll as explained in FIGS. 10a-10b and 11a-11b.

FIG. 8b extends FIG. 1 by showing an embodiment of a set of possible generalized interface elements and regions that might appear in the content display area, 106, when in Within Application Mode for applications with overflow content that may not fit in the bounds of the display, such as the mail application embodiment presented in FIG. 5a-5e. Similar to FIG. 8a, the interface regions such as 102 and 104 along the outer ring 100 correspond to actions within the context of an application, some of which may help to view overflow content, 258, with the up, 182, and down, 196, arrow actions such as in FIGS. 5c and 5d. In the touchscreen hardware manifestation, swiping up and down on the content produces the same effect as the up and down arrow actions. The overflow content, 258, could also be an image, map, and may be a shape other than a rectangle. As such, actions to navigate the overflow content may include more than just up and down and include additional directions such as left, right, upper left, upper right, and so on. In the touchscreen hardware manifestation, additional gestures such as pinch to zoom and dragging may be possible to navigate the content. Scrolling functionality, particularly in hardware manifestations without a touchscreen, could also be used to zoom in and out: e.g., up, down, left, and right actions could move a pointer around and scrolling functionality could zoom in and out at that pointer.

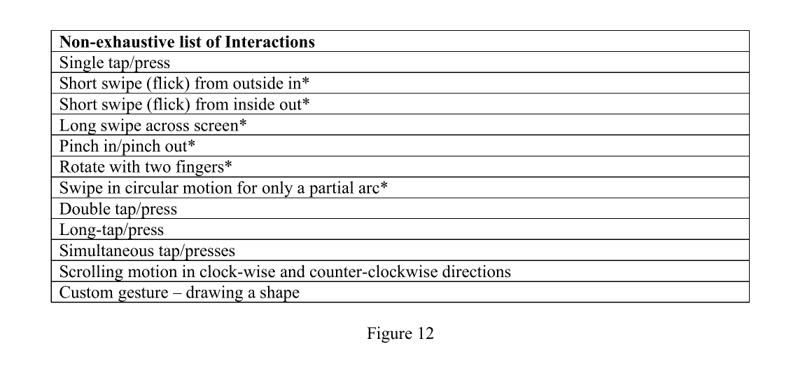

FIG. 9a demonstrates the touchscreen hardware manifestation of the circular interface using an overhead view, according to some embodiments of the present disclosure. The touchscreen is indicated by 260, and the bezel is indicated by 262. Peripheral buttons or sensors may appear around the sides of the device, 264, 266, 270, or 272, or on the bezel itself, 268. Buttons or sensors may not necessarily have the number of buttons or sensors displayed in this figure, or otherwise be placed in the displayed configuration. Buttons or sensors may be rectangular, circular, or take on other reasonable outlines. The touchscreen, 260, affords itself all gestures that would be available on any touchscreen, a non-exhaustive list of which is outlined in FIG. 12.

FIGS. 9b and 9c demonstrate embodiments of some of the user interactions available on the touchscreen hardware manifestation of the circular interface.

Application Switching Mode could be engaged using a few alternatives: 1) One of the buttons or sensors on the sides of the device, such as 264, 266, 270, or 272, could be responsible for engaging Application Switching Mode. Pressing this button or sensor would also disengage Application Switching Mode if the user decides to cancel Application Switching Mode before he/she selects an application to switch to. 2) A pinch-in gesture shown on FIG. 9c with 284 on the touchscreen could be responsible for engaging Application Switching Mode. A pinch-out gesture could disengage Application Switching Mode.

Back button or home button functionality could be engaged using a few alternatives: 1) A button or sensor on the sides of the device, such as 264, 266, 270, or 272, but different from the one assigned to Application Switching Mode could be responsible for back button or home button functionality. The user could also use multiple buttons or sensors at once: e.g., in the case of having two buttons or sensors, one for application switching and one for the back button, activating both at the same time could provide a third, e.g., home, button functionality. 2) Instead of having pinch-out and pinch-in responsible for Application Switching Mode on FIG. 9c with 284, a pinch-in gesture could provide back button functionality. 3) Swiping on the outer ring, 100, in a clockwise or counterclockwise fashion as shown on FIG. 9b with 274 could provide back button and forward button functionality. 4) A custom swiping gesture such as effectively drawing an arc pointing to the left or some other shape, on FIG. 9c with 286, could have back button functionality.

Selecting one of the interface regions for selecting an application in Application Switching Mode or selecting an action in Within Application Mode can be specified by a few alternatives: a tap, 280, or a swipe, 276. This allows for selection of applications in Application Switching Mode and selecting actions in Within Application Mode. Scrolling functionality can be provided with a clockwise or counterclockwise touch gesture, 278. The notifications panel can be opened by a long swipe down on the notifications bar, 282. Other user interactions, such as a long-tap or double-tap, are listed in FIG. 12.

FIG. 10a demonstrates the capacitive touch hardware manifestation of the circular interface using an overhead view, according to some embodiments of the present disclosure. A screen likely without touchscreen functionality is indicated by 288. Peripheral buttons or sensors may appear around the sides of the device, 264, 266, 270, or 272, and these buttons or sensors may not necessarily have number of buttons or sensors displayed in this figure or otherwise be placed in the displayed configuration. Buttons or sensors may be rectangular, circular, or take on other reasonable outlines. The bezel 262 can have a fixed number of capacitive touch sensor regions, in this case eight, 290, 292, 294, 296, 298, 300, 302, and 304, each mapped to an interface region around the outer ring 100. In this hardware manifestation, if there are more interface regions on the display than the fixed number of capacitive touch sensor regions, then the user cannot directly select an action or application along the outer ring and it may require a series of additional interactions, such as those specified in FIG. 6b for the example contacts application.

FIG. 10b demonstrates embodiments of some of the user interactions available on the capacitive touch hardware manifestation of the circular interface.

Application Switching Mode can be engaged using one of the buttons or sensors on the sides of the device, such as 264, 266, 270, or 272, that are responsible for engaging Application Switching Mode. Pressing this button or sensor can also disengage Application Switching Mode if the user decides to cancel Application Switching Mode before he/she selects an application to switch to.

Back button or home button functionality can be engaged by using a button or sensor on the sides of the device, such as 264, 266, 270, or 272, but different from the one assigned to Application Switching Mode. The user could also use multiple buttons or sensors at once: e.g., in the case of having two buttons or sensors, one for application switching and one for the back button, activating both at the same time could provide a third, e.g., home, button functionality.

Tapping one of the capacitive touch sensor regions, 306, can allow the selection of applications in Application Switching Mode and selecting actions in Within Application Mode. Tapping an interface region twice or holding it for a long tap, 308, can select the secondary action attached to this region, e.g., opening the notifications panel using the notifications bar. A scrolling gesture along the capacitive touch regions, 310, can allow for scrolling functionality.

FIG. 11a demonstrates the physical control hardware manifestation of the circular interface using an overhead view, according to some embodiments of the present disclosure. A screen likely without touchscreen functionality is indicated by 288. Peripheral buttons or sensors may appear around the sides of the device, 264, 270, or 272, and these buttons or sensors may not necessarily have number of buttons or sensors displayed in this figure or otherwise be placed in the displayed configuration. Buttons or sensors may be rectangular, circular, or take on other reasonable outlines. The bezel, 262, can have a fixed number of physical button regions, in this case eight, 310, 312, 314, 316, 318, 320, 322, and 324, each mapped to an interface region around the outer ring, 100. In this hardware manifestation, if there are more interface regions on the display than the fixed number of physical button regions, then the user cannot directly select an action or application along the outer ring and it requires additional interactions, such as those specified in FIG. 6b for the example contacts application. There can also be a rotating wheel on one side of the device, 308, that rotates in a clockwise or counterclockwise direction.

FIG. 11b demonstrates embodiments of some of the user interactions available on the physical control hardware manifestation of the circular interface.

Application Switching Mode is engaged using one of the buttons or sensors, such as 264, 266, 270, or 272, that are responsible for engaging Application Switching Mode. Pressing this button or sensor would also disengage Application Switching Mode if the user decides to cancel Application Switching Mode before he/she selects an application to switch to.

Back button or home button functionality is engaged by using a button or sensor around the sides of the device, such as 264, 270, or 272, but different from the one assigned to Application Switching Mode. The user could also use multiple buttons or sensors at once: e.g., in the case of having two buttons or sensors, one for application switching and one for the back button, activating both at the same time could provide a third, e.g., home, button functionality.

Pressing one of the physical control button regions, 326, allows the selection of applications in Application Switching Mode and selecting actions in Within Application Mode. Pressing an interface region twice or holding it for a long press, 328, selects the secondary action attached to this region, e.g., opening the notifications panel using the notifications bar. The rotating wheel, 330, allows for scrolling functionality.

FIG. 12 is a list of interactions the circular interface can process. Those that are asterisked are those interactions available for the touchscreen hardware manifestation. These interactions can include, for example, single tap/press, short swipe (flick) from outside in*, short swipe (flick) from inside out*, long swipe across screen*, pinch in/pinch out*, rotate with two fingers*, swipe in circular motion for only a partial arc*, double tap/press, long-tap/press, simultaneous tap/presses, scrolling motion in clockwise and counterclockwise directions, and custom gesture—drawing a shape.

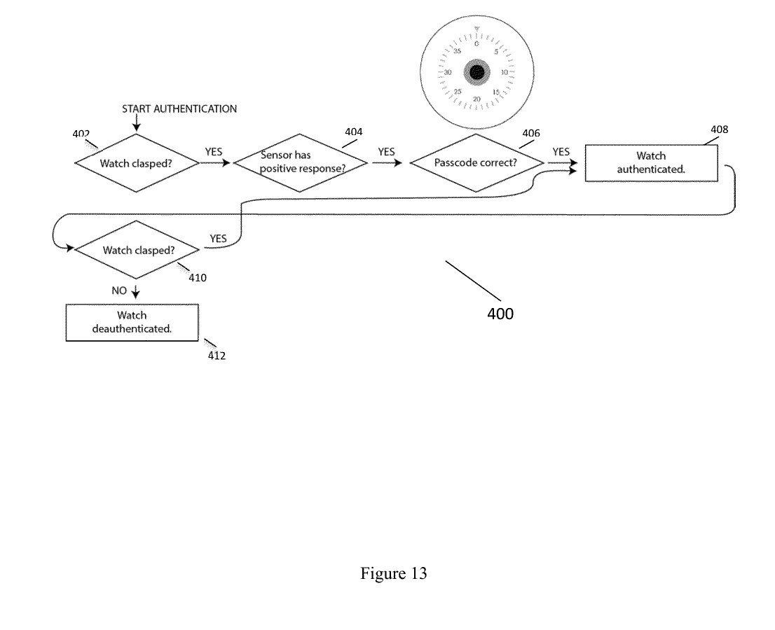

FIG. 13 shows an authentication 400 for a wearable computer such as a watch. Once the watch is clasped 402 and a sensor such as a heart rate detector, sweat capacitance sensor, and/or another appropriate sensor provides a positive response 404 by detecting that the watch is not loose and/or determines with some high probability the quality of a human being alive, the user can enter a passcode 406, as an example a combination lock code using the circular design paradigm. This allows the watch to remain authenticated 408 until it is taken off so applications can be sure the correct user is wearing the watch. Other wearable computers might use different mechanisms for detecting if the wearable is still on the person while still using this framework. For example, if the watch becomes unclasped 410, the watch can be deauthenticated 412.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A wearable electronic device comprising:
a circular display region which displays content from an application;
an annular outer ring, wherein the annular outer ring surrounds the circular display region, and wherein the annular outer ring is subdivided into a plurality of interface regions, wherein:
each of the plurality of interface regions displays an interface action and may be interacted with separately from the other interface regions of the plurality of interface regions, and
wherein the device is configured to support at least two interaction modes such that:
when the device is configured in a within application mode, each of the plurality of interface regions may be interacted with to perform an action specific to the application currently displaying content in the circular display region,
when the device is configured in an application switching mode, at least one of the plurality of interface regions may be interacted with to switch the circular display region to display content from a different application and one of the plurality of interface regions may be interacted with to return to the application currently displaying content in the circular display region.

2. The device of claim 1, wherein the plurality of interface regions are evenly spaced around the annular outer ring.

3. The device of claim 1, wherein one or more of the circular display region and the annular outer ring is a touchscreen.

4. The device of claim 1, wherein the circular display region and the annular outer ring are sub-regions of a touchscreen.

5. The device of claim 1, wherein the annular outer ring comprises a plurality of capacitive touch sensors, wherein each capacitive touch sensor corresponds to one of the plurality of interface regions.

6. The device of claim 1, wherein the annular outer ring comprises a plurality of physical buttons on a bezel of the device, wherein each of the plurality of physical buttons corresponds to one of the plurality of interface regions.

7. The device of claim 1, wherein the annular outer ring is configured to recognize one or more of a clockwise scrolling gesture and a counter-clockwise scrolling gesture.

8. The device of claim 1 further comprising:
a strap for attachment to a user's wrist, wherein the strap is attached to the device at two points placed opposite to one another on the device, and
a rotating interface wheel placed on a side of the device, wherein the rotating interface wheel is placed such that a line drawn from the wheel to the center of the device is substantially perpendicular to a line drawn between the points at which the strap attaches to the device.

9. The device of claim 1, wherein the number of interface regions in the plurality of interface regions changes during use.

10. The device of claim 1, further comprising at least one additional interface region located on the side of the device, wherein the device is configured to recognize interaction with the additional interface region as a command selected from the group of: a mode switch command that switches the current interaction mode of the device, a back command, and a home command.

11. The device of claim 10, wherein the interface region is a sensor.

12. A method of providing an interface for a wearable electronic device, comprising:
displaying an application in a circular display region of a device;
displaying interface actions in a plurality of interface regions located on an annular outer ring surrounding the circular display region, wherein
in an application specific mode the interface actions are specific to the application currently displayed in the circular display region and
in an application switching mode all but one of the plurality of interface regions display an interface action which switches to one of a plurality of different applications while the remaining interface region displays an interface action which returns to the current application;
receiving an action input in response to a user selection of one of the plurality of interface regions; and
performing an action corresponding to the selected interface region and the current mode.

13. The method of claim 12, further comprising flashing the annular outer ring to indicate a new notification.

14. The method of claim 12, further comprising recognizing a gesture on a touchscreen, wherein recognizing the gesture toggles between the application specific mode and the application switching mode.

15. The method of claim 14, wherein the gesture is one of pinching in or pinching out.

16. The method of claim 12, further comprising receiving an action input in response to user activation of at least one additional interface region on the side of the device, wherein performing an action further comprises toggling between the application specific mode and the application switching mode.

17. The method of claim 12, further comprising receiving an alternate action input in response to an alternate user interaction with one of the plurality of interface regions, wherein the alternate user interaction comprises one of a long press, a double press, or a simultaneous press of at least two of the plurality of interface regions.

18. The method of claim 12, further comprising locking the interface if a sensor in the device detects that the device has been removed from the wrist of a user.

19. The method of claim 12, wherein the device comprises a strap for attachment to a user's wrist, wherein the strap is attached to the device at two points placed opposite to one another on the device, and a rotating interface wheel placed on a side of the device, wherein the rotating interface wheel is placed such that a line drawn from the wheel to the center of the device is substantially perpendicular to a line drawn between the points at which the strap attaches to the device.

20. The method of claim 19, further comprising performing a scrolling action based on user interaction with the rotating interface wheel.
